(19) United States
(12) Patent Application Publication
(10) Pub. No.: US 2009/0087014 A1
(43) Pub. Date: Apr. 2, 2009

(54) SKEW/DOUBLEFEED DETECTION IN SCANNED IMAGES

(75) Inventors: Mark D. Goodwin, Apalachin, NY (US); Matthew S. Hale, Barton, NY (US)

Correspondence Address: BURNS & LEVINSON, LLP, 125 SUMMER STREET, BOSTON, MA, 02110, US

(73) Assignee: LOCKHEED MARTIN CORPORATION, Bethesda, MD (US)

(21) Appl. No.: 11/865,259

(22) Filed: Oct. 1, 2007

(51) Int. Cl. G06K 9/00

(52) U.S. Cl. 382/100

(57) ABSTRACT

A system and method for identifying a status such as, for example, skew and/or double feed, of a scanned image.

### BACKGROUND

The system and method of the present embodiment relate generally to scanned item processing, and more particularly to scanned items which are improperly presented to a scanning device. Scanned items, such as, for example, mail, can be presented to a scanning device such that, for example, they are rotated and/or two items can be fed such that they overlap one another. To correct such improper presentation has historically involved intensive processing.

### SUMMARY

In one embodiment, the system and method of the present disclosure identify a status of a scanned image by selecting a scan line within a pre-selected section of the scanned image, comparing each of a plurality of pixels in the selected scan line to a pre-selected threshold, computing a first dimension for the selected scan line at an uppermost pixel of the plurality of pixels having a value that is above the pre-selected threshold, computing a second dimension for the selected scan line at a lowest pixel of the plurality of pixels having a value that is above the pre-selected threshold, averaging the first dimension and the second dimension over the pre-selected section, repeating the previous steps for each pre-selected section of the scanned image, calculating a first edge from the averaged first dimensions and a second edge from the averaged second dimensions for the pre-selected sections of the scanned image, and identifying the status of the scanned image based on characteristics of the first edge and the second edge.

For a better understanding of the present embodiment, reference is made to the accompanying drawings and detailed description.

### DESCRIPTION OF THE SEVERAL VIEWS OF THE DRAWING

FIG. 1 is a schematic block diagram of the components of an embodiment described herein;

FIG. 2 is a flowchart of the method of the embodiment described herein; pictorial representation of a scanned image with overscan area;

FIG. 3 is a pictorial representation of a scanned image having a first overscan area;

FIG. 4 is a pictorial representation of a scanned image having overscan areas on all four edges;

FIG. 5 is a pictorial representation of a scanned image having foreground and background mail pieces;

FIG. 6 is a pictorial representation of a scanned image having a skewed mail piece;

FIG. 7 is a pictorial representation of a scanned image illustrating pre-selected sections of a scanned image;

FIG. 8 is a pictorial representation of a scanned image having double-fed mail pieces with stepped edges;

FIG. 9 is a pictorial representation of a scanned image having double-fed mail pieces with stepped edges and showing pre-selected sections of the mail pieces; and

FIG. 10 is a pictorial representation of a scanned image having a skewed mail piece and showing pre-selected sections of the mail piece.

### DETAILED DESCRIPTION OF THE DISCLOSURE

The present system is now described more fully hereinafiter with reference to the accompanying drawings, in which the illustrative embodiment of the present disclosure is shown. The following configuration description is presented for illustrative purposes only. Any computer configuration satisfying the speed and interface requirements herein described may be suitable for implementing the system of the present disclosure.

The system and method of the present embodiment detect improper presentation to a scanning device by determining the boundary between a dark background and a lighter scanned image. This process can be done at regular intervals and from those data, a profile of the top of the scanned image can be developed. The angle of the profile from a reference such as horizontal, for example, can be used to determine an angle of skew. This skew angle can be used to reset a horizontal reference axis for the scanned image. In addition, a discontinuity in the profile can be used to indicate that the scanned image includes a double feed. One possible action that could be taken is to prevent further processing of the scanned image. The boundary of the second edge of the scanned image could also be determined. A skewed scanned image could be detected by determining if the first and second edges were parallel, whereas a double feed could be determined by detecting a solid bottom boundary with a discontinuous top boundary.

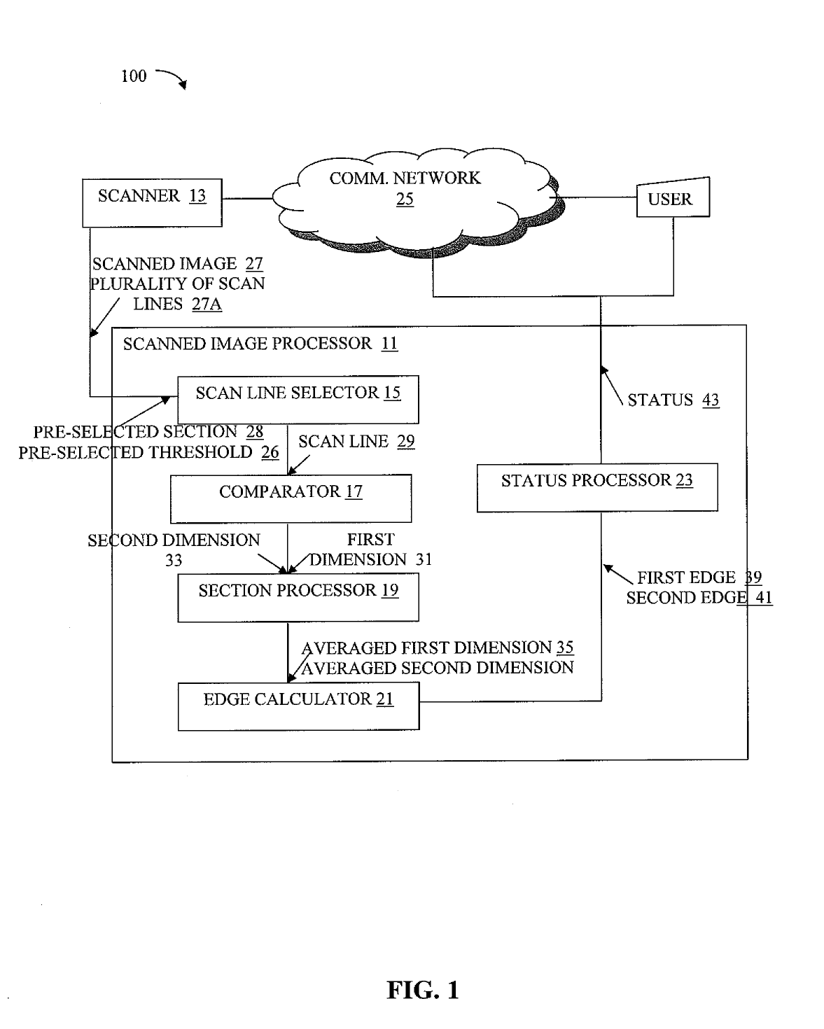

Referring now primarily to FIG. 1, system 100 for identifying a status 43 such as, for example, skew and/or double feed, of a scanned image 27 can include, but it not limited to including, scanned image processor 11 for executing scan line selector 15, comparator 17, section processor 19, edge calculator 21, and status processor 23. System 100 can received scanned images 27 from scanner 13, for example, or any other means, for example, from communications network 25. Status 43 can be provided to, for example, a user, another machine that processes scanned images 27, communications network 25, or any other appropriate receiver.

Continuing to refer to FIG. 1, scan line selector 15 can be configured to select scan line 29 from a plurality of scan lines 27A within pre-selected section 28 of scanned image 27. Pre-selected section 28 can include any number of scan lines 29, for example, 64 or 256. Comparator 17 can be configured to compare each of a plurality of pixels in the selected scan line to pre-selected threshold 26, and can be configured to compute first dimension 31 for the selected scan line at an uppermost pixel of the plurality of pixels having a value that is above pre-selected threshold 26. Pre-selected threshold 26 can be set at, for example, 20%, but any value can be used, depending on the configuration and characteristics of scanned image 27. Comparator 17 can also be configured to compute second dimension 33 for the selected scan line at a lowest pixel of the plurality of pixels having a value that is above pre-selected threshold 26. Section processor 19 can be configured to compute averaged first dimension 35 from values for first dimension 31 over plurality of scan lines 27A in pre-selected section 28, and averaged second dimension 37 from values for second dimension 33 over plurality of scan lines 27A in pre-selected section 28. Section processor 19 can also be configured to compute averaged first dimension 35 and averaged second dimension 37 for each pre-selected section 28 of scanned image 27. Edge calculator 21 can be configured to calculate first edge 39 from averaged first dimensions 35 and second edge 41 from averaged second dimensions 37 for pre-selected sections 26 of scanned image 27. Status processor 23 can be configured to identify status 43 of scanned image 27 based on characteristics of first edge 39 and second edge 41. Status processor 23 can optionally be further configured to discard the selected scan line if none of the plurality of pixels is above pre-selected threshold 26.

Continuing to still further refer to FIG. 1, comparator 17 can optionally be further configured to (a) determine a maximum first dimension for each pre-selected section 28, (b) determine a maximum second dimension for each pre-selected section 28, (c) assign the maximum first dimension for the selected scan line if no pixel of the plurality of pixels is above pre-selected threshold 26, and (d) assign the maximum second dimension for the selected scan line if no pixel of the plurality of pixels is above pre-selected threshold 26. Comparator 17 can still further be configured to (a) determine a minimum first dimension for each of pre-selected sections 28 (b) determine a minimum second dimension for each pre-selected section 28, (c) assign the minimum first dimension for the selected scan line if no pixel of the plurality of pixels is above pre-selected threshold 26, and (d) assign the minimum second dimension for the selected scan line if no pixel of the plurality of pixels is above pre-selected threshold 26. Comparator 17 can even still further be configured to (a) determine a maximum first dimension and a minimum first dimension for each of pre-selected sections 28, (b) determine a maximum second dimension and a minimum second dimension for each of pre-selected sections 28, and (c) discard the maximum first dimension, the minimum first dimension, the maximum second dimension, and the minimum second dimension.

Continuing to even still further refer to FIG. 1, status processor 23 can be further configured to (a) calculate a first skew angle of first edge 39, (b) calculate a second skew angle of second edge 41, and (c) identify scanned image 27 as a double feed if the first skew angle and the second skew angle are not substantially equal. Status processor 23 can be even further configured to identify scanned image 27 as a double feed if there is at least one step in first edge 39 or if there is at least one step in second edge 41.

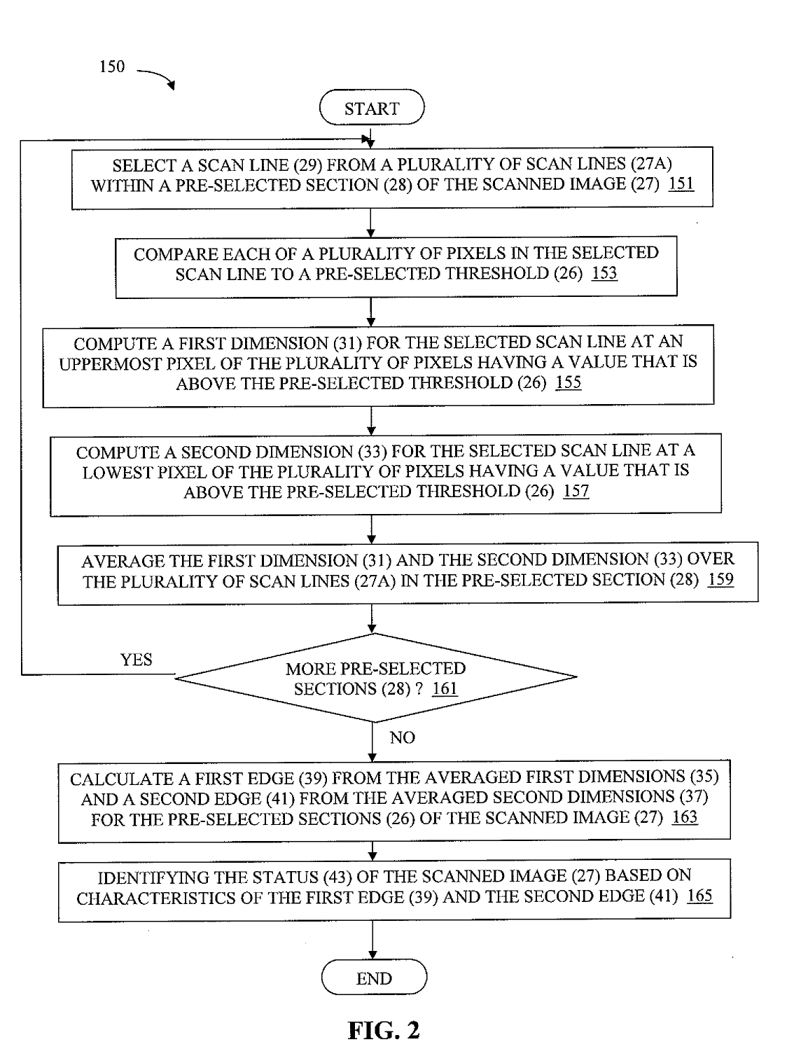

Referring now primarily to FIG. 2, method 150 for identifying status 43 (FIG. 1) of scanned image 27 (FIG. 1) can include, but is not limited to including, the steps of (a) selecting 151 a scan line 29 (FIG. 1) from plurality of scan lines 27A (FIG. 1) within pre-selected section 28 (FIG. 1) of scanned image 27 (FIG. 1); (b) comparing 153 each of a plurality of pixels in the selected scan line to pre-selected threshold 26 (FIG. 1); (c) computing 155 first dimension 31 (FIG. 1) for the selected scan line at an uppermost pixel of the plurality of pixels having a value that is above pre-selected threshold 26 (FIG. 1); (d) computing 157 second dimension 33 (FIG. 1) for the selected scan line at a lowest pixel of the plurality of pixels having a value that is above pre-selected threshold 26 (FIG. 1); (e) averaging 159 first dimension 31 (FIG. 1) and second dimension 33 (FIG. 1) over plurality of scan lines 27A (FIG. 1) in pre-selected section 28 (FIG. 1); (f) repeating 161 steps (a)-(e) for each pre-selected section 28 (FIG. 1) of scanned image 27 (FIG. 1); (g) calculating 163 first edge 39 (FIG. 1) from averaged first dimensions 35 (FIG. 1) and second edge 41 (FIG. 1) from averaged second dimensions 37 (FIG. 1) for pre-selected sections 26 (FIG. 1) of scanned image 27 (FIG. 1); and (h) identifying 165 status 43 (FIG. 1) of scanned image 27 (FIG. 1) based on characteristics of first edge 39 (FIG. 1) and second edge 41 (FIG. 1).

Referring again to FIG. 1, method 150 can further optionally include the step of discarding the selected scan line if none of the plurality of pixels is above pre-selected threshold 26 (FIG. 1). Method 150 can further optionally include the steps of determining a maximum first dimension for each of pre-selected sections 28 (FIG. 1); determining a maximum second dimension for each of pre-selected sections 28 (FIG. 1); assigning the maximum first dimension for the selected scan line if no pixel of the plurality of pixels is above pre-selected threshold 26 (FIG. 1); and assigning the maximum second dimension for the selected scan line if no pixel of the plurality of pixels is above pre-selected threshold 26 FIG. 1). Method 150 can still further optionally include the steps of determining a minimum first dimension for each of pre-selected sections 28 (FIG. 1), determining a minimum second dimension for each of pre-selected sections 28 (FIG. 1), assigning the minimum first dimension for the selected scan line if no pixel of the plurality of pixels is above pre-selected threshold 26 (FIG. 1), and assigning the minimum second dimension for the selected scan line if no pixel of the plurality of pixels is above pre-selected threshold 26 (FIG. 1). Method 150 can even still further include the steps of determining a maximum first dimension and a minimum first dimension for each of pre-selected sections 28 (FIG. 1), determining a maximum second dimension and a minimum second dimension for each of pre-selected sections 28 (FIG. 1), and discarding the maximum first dimension, the minimum first dimension, the maximum second dimension, and the minimum second dimension. Method 150 can yet still further include the optional steps of calculating a first skew angle of first edge 39 (FIG. 1), calculating a second skew angle of second edge 41 (FIG. 1), and identifying scanned image 27 as a double feed if the first skew angle and the second skew angle are not substantially equal. Method 150 can still further include the optional step of identifying scanned image 27 (FIG. 1) as a double feed if there is at least one step in first edge 39 (FIG. 1) or if there is at least one step in second edge 41 (FIG. 1).

Referring to FIGS. 1 and 2, method 150 (FIG. 2) can be, in whole or in part, implemented electronically. Signals representing actions taken by elements of system 100 (FIG. 1) can travel over electronic communications media and from node to node in communications network 25 (FIG. 1). Control and data information can be electronically executed and stored on computer-readable media. Method 150 (FIG. 2) can be implemented to execute on a node in computer communications network 25 (FIG. 1). Common forms of computer-readable media include, but are not limited to, for example, a floppy disk, a flexible disk, a hard disk, magnetic tape, or any other magnetic medium, a CDROM or any other optical medium, punched cards, paper tape, or any other physical medium with patterns of holes, a RAM, a PROM, and EPROM, a FLASH-EPROM, or any other memory chip or cartridge, a carrier wave, electronic signal, or any other medium from which a computer can read. System 100 (FIG. 2) can include communications network 25 (FIG. 2) that can include at least one node for carrying out method 150 (FIG. 2). System 100 (FIG. 2) can include a computer data signal embodied in electromagnetic signals traveling over communications network 25 (FIG. 2) carrying information capable of causing a computer system in communications network 25 (FIG. 2) to practice method 150 (FIG. 2). System 100 (FIG. 2) can include a computer readable medium having instructions embodied therein for the practice of method 150 (FIG. 2).

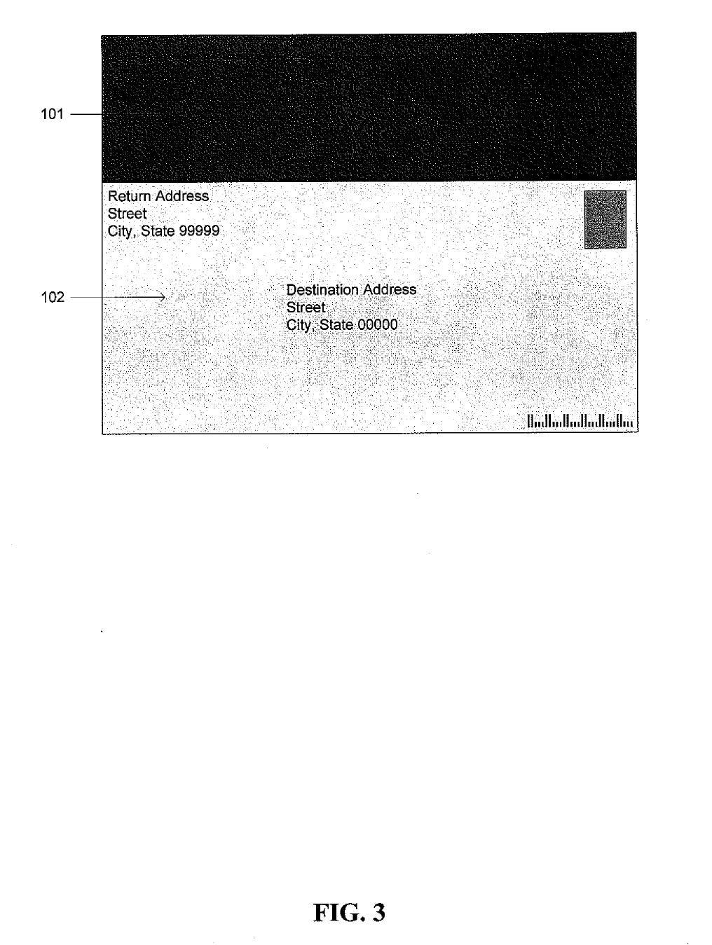

Referring now to FIG. 3, mail piece 102, an example of scanned image 27, is shown having first overscan area 101.

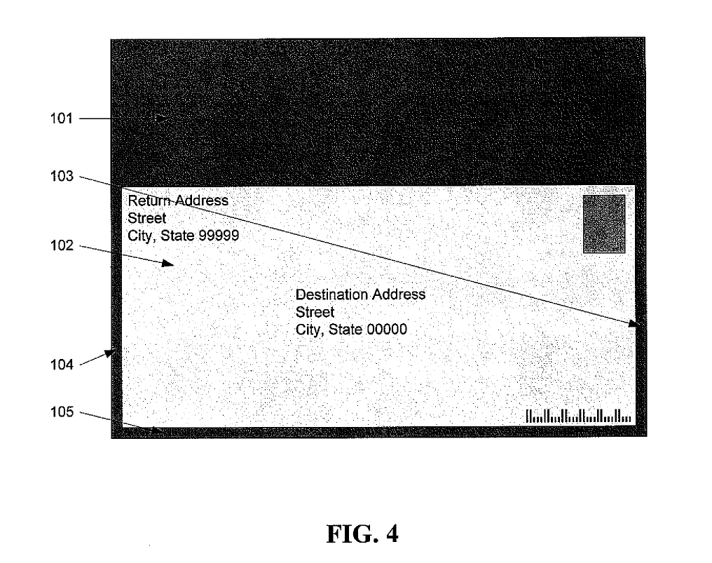

Referring now primarily to FIG. 4, the overscan areas on all four edges of mail piece 102 are shown. Leading overscan area 103 can be caused by an early trigger of mail piece 102 presence detection. Trailing overscan area 104 can be caused by a late release of mail piece 102 presence detection. Second overscan area 105 can be caused by mail piece 102 riding high on the conveyor belt. First overscan area 101 can be caused by mail piece 102 being shorter than the maximum scan height. Overscan areas are generally darker than mail piece 102, for example, under 10% grayscale. Note that a grayscale of 0% is perfect black and a grayscale of 100% is perfect white. Illumination and calibration can affects the ranges of scanned grayscales. As an example, the background of a white envelope is typically over 80% grayscale, but can be as low as 20% on the darkest envelopes.

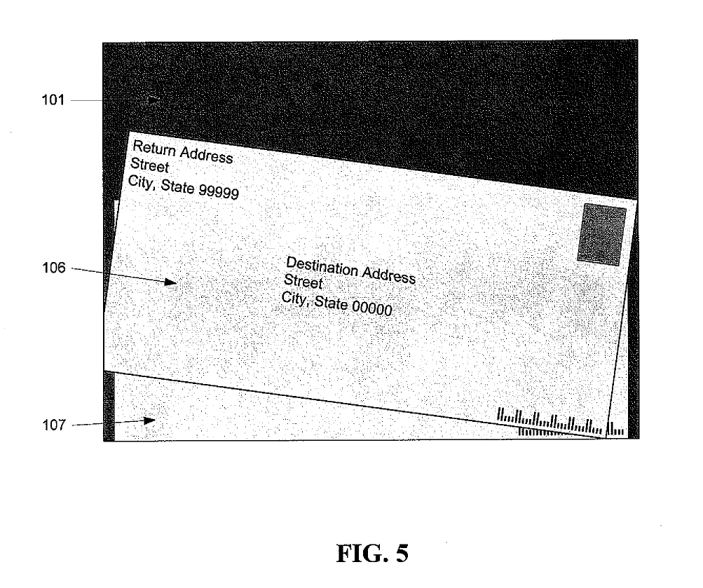

Referring now primarily to FIG. 5, foreground mail piece 106 and background mail piece 107 have been fed together as a double feed. Foreground mail piece 106 provides primary information (address and barcodes) for sortation. Both mail pieces are sorted together. In this case, first overscan area 101 has its lower edge at an angle. Second overscan area 105, shown with no height in this example, is zero. These characteristics of the mail pieces and overscan areas indicate a double feed with one mail piece rotated.

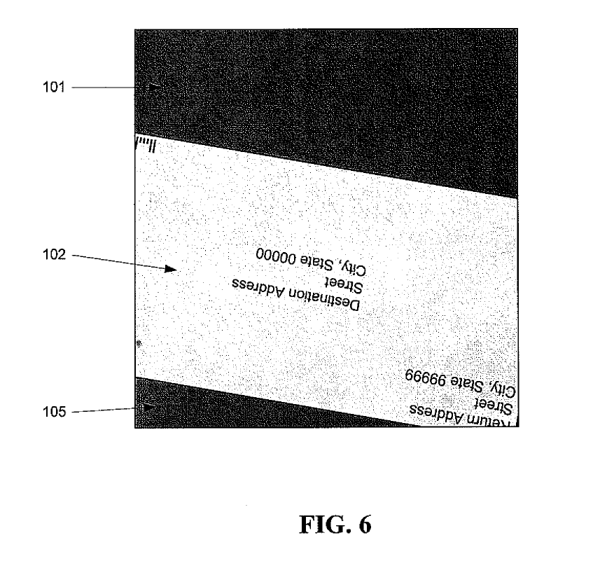

Referring now primarily to FIG. 6, misfed mail piece 102 is rotated. Reading an address with significant rotation requires that scanned image 27 (FIG. 1) be first rotated. The lower edge of first overscan area 101 is not horizontal. The upper edge of second overscan area 105 is also not horizontal, and has the same angle with respect to a horizontal reference as the lower edge of first overscan area 101, indicating a single rotated mail piece 102.

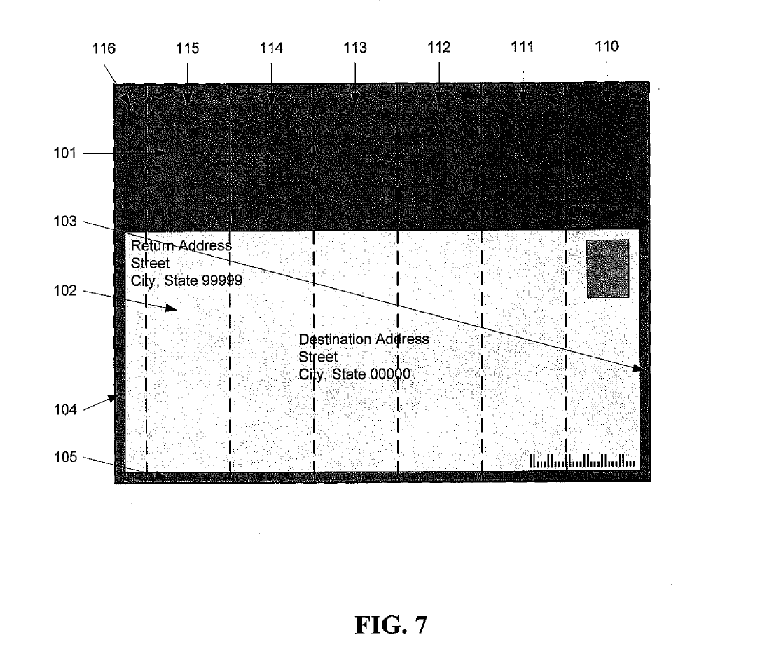

Referring now primarily to FIG. 7, pre-selected sections 28 (FIG. 1) of scanned image 27 (FIG. 1), are shown here as sections 110-116. Pre-selected sections 28 (FIG. 1) can be of any width, with last pre-selected section 116 possibly being narrower than the previous pre-selected sections 110-115. The height of mail piece 102 in each pre-selected section 28 (FIG. 1) is determined by finding the highest light pixel in each pre-selected section 28 (FIG. 1). A light pixel is defined as when the grayscale is the pixel is above pre-selected threshold 26 (FIG. 1), for example above 20%. Averaging pixel values within pre-selected section 28 (FIG. 1) can provide for noise immunity and avoidance of dark areas on mail piece 102. The width of the vertical sections can be selected for optimum performance depending upon characteristics of scanned image 27 (FIG. 1).

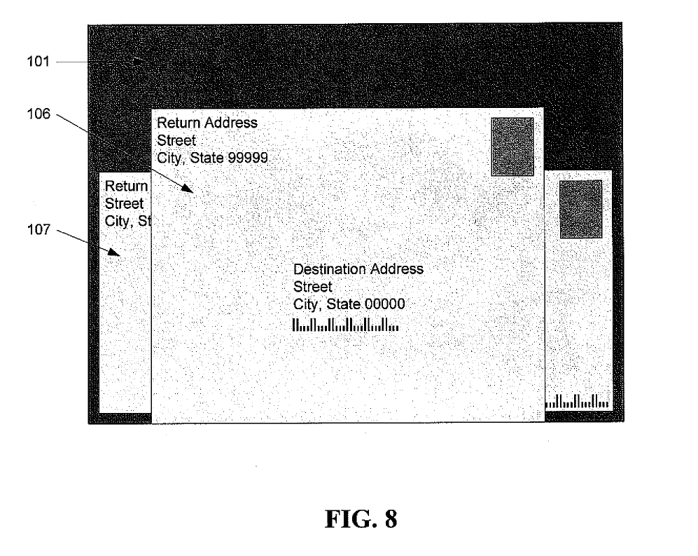

Referring now primarily to FIG. 8, foreground mail piece 106 and background mail piece 107 have been fed together. First overscan area 101 indicates the double feed with steps in its normally horizontal lower edge. Foreground mail piece 106 can provide primary information (address and barcodes) for sortation. Both mail pieces are sorted together.

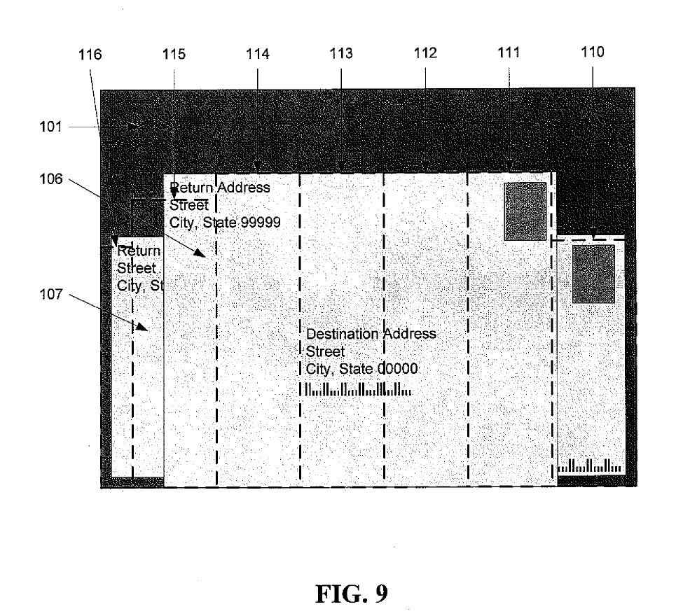

Referring now primarily to FIG. 9, foreground mail piece 106 and background mail piece 107 have been double fed causing a non-horizontal first overscan area 101. The profile of pre-selected sections 28 (FIG. 1), shown here as sections 110-116, of scanned image 27 (FIG. 1) shows that a double fed has occurred. Mail pieces can be processed accordingly, probably sorted to a reject bin.

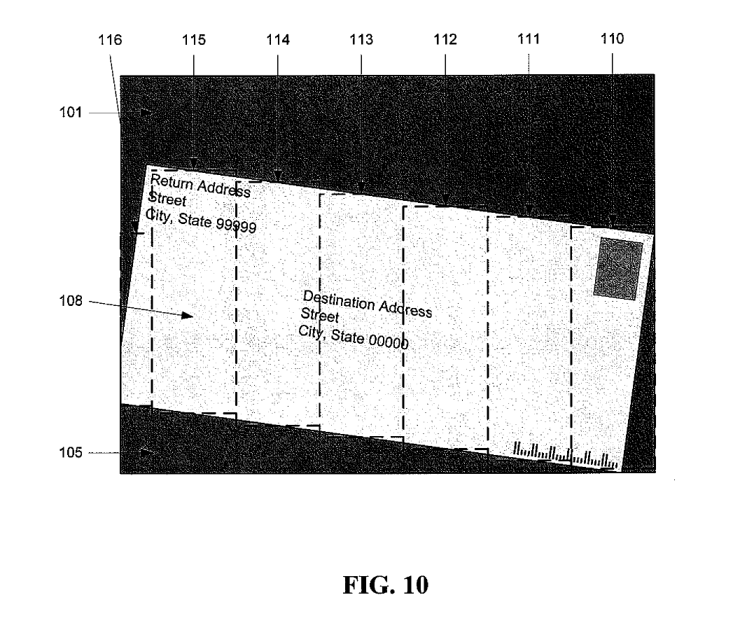

Referring now primarily to FIG. 10, misfed mail piece 108 is shown as rotated. First overscan area 101 has its lower edge at an angle with horizontal, which is detected by the top profile of pre-selected sections 28 (FIG. 1), shown here as sections 110-116, of scanned image 27 (FIG. 1). The upper edge of second overscan area 105 lies at the same angle with horizontal as the lower edge of first overscan area 111, which is detected by the top profile of pre-selected sections 28 (FIG. 1) of scanned image 27 (FIG. 1). Equal rotations of the top and bottom profiles indicate a single rotated mail piece.

Although the disclosure has been described with respect to various embodiments, it should be realized this disclosure is also capable of a wide variety of further and other embodiments.

What is claimed is:

1. A method for identifying a status of a scanned image comprising the steps of:
(a) selecting a scan line from a plurality of scan lines within a pre-selected section of the scanned image;
(b) comparing each of a plurality of pixels in the selected scan line to a pre-selected threshold;
(c) computing a first dimension for the selected scan line at an uppermost pixel of the plurality of pixels having a value that is above the pre-selected threshold;
(d) computing a second dimension for the selected scan line at a lowest pixel of the plurality of pixels having a value that is above the pre-selected threshold;
(e) averaging the first dimension and the second dimension over the plurality of scan lines in the pre-selected section;
(f) repeating steps (a)-(e) for each pre-selected section of the scanned image;
(g) calculating a first edge from the averaged first dimensions and a second edge from the averaged second dimensions for the pre-selected sections of the scanned image; and
(h) identifying the status of the scanned image based on characteristics of the first edge and the second edge.

2. The method of claim 1 wherein the first dimension is a top height of the selected scan line.

3. The method of claim 1 wherein the second dimension is a bottom height of the selected scan line.

4. The method of claim 1 wherein the pre-selected threshold is about 20%.

5. The method of claim 1 further comprising the step of:
discarding the selected scan line if none of the plurality of pixels is above the pre-selected threshold.

6. The method of claim 1 further comprising the steps of:
determining a maximum first dimension for each of the pre-selected sections;
determining a maximum second dimension for each of the pre-selected sections;
assigning the maximum first dimension for the selected scan line if no pixel of the plurality of pixels is above the pre-selected threshold; and
assigning the maximum second dimension for the selected scan line if no pixel of the plurality of pixels is above the pre-selected threshold.

7. The method of claim 1 further comprising the steps of:
determining a minimum first dimension for each of the pre-selected sections;
determining a minimum second dimension for each of the pre-selected sections;
assigning the minimum first dimension for the selected scan line if no pixel of the plurality of pixels is above the pre-selected threshold; and
assigning the minimum second dimension for the selected scan line if no pixel of the plurality of pixels is above the pre-selected threshold.

8. The method of claim 1 further comprising the steps of:
determining a maximum first dimension and a minimum first dimension for each of the pre-selected sections;
determining a maximum second dimension and a minimum second dimension for each of the pre-selected sections; and
discarding the maximum first dimension, the minimum first dimension, the maximum second dimension, and the minimum second dimension.

9. The method of claim 1 wherein the pre-selected section includes about 256 of the scan lines.

10. The method of claim 1 wherein the pre-selected section includes about 64 of the scan lines.

11. The method of claim 1 further comprising the steps of:
calculating a first skew angle of the first edge;
calculating a second skew angle of the second edge; and
identifying the scanned image as a double feed if the first skew angle and the second skew angle are not substantially equal.

12. The method of claim 1 further comprising the step of:
identifying the scanned image as a double feed if there is at least one step in the first edge or if there is at least one step in the second edge.

13. A system for identifying a status of a scanned image comprising:
a scan line selector configured to select a scan line from a plurality of scan lines within a pre-selected section of the scanned image;
a comparator configured to compare each of a plurality of pixels in the selected scan line to a pre-selected threshold, said comparator configured to compute a first dimension for the selected scan line at an uppermost pixel of said plurality of pixels having a value that is above the said selected threshold, said comparator configured to compute a second dimension for the selected scan line at a lowest pixel of said plurality of pixels having a value that is above the pre-selected threshold;
a section processor configured to compute an averaged first dimension from values for said first dimension over said plurality of scan lines in said pre-selected section, and an averaged second dimension from values for said second dimension over said plurality of scan lines in said pre-selected section, said section processor configured to compute said averaged first dimension and said averaged second dimension for each said pre-selected section of said scanned image;
an edge calculator configured to calculate a first edge from said averaged first dimensions and a second edge from said averaged second dimensions for said pre-selected sections of said scanned image; and
a status processor configured to identify said status of said scanned image based on characteristics of said first edge and said second edge.

14. The system of claim 13 wherein said pre-selected threshold is about 20%.

15. The system of claim 13 wherein said status processor is further configured to discard the selected scan line if none of the plurality of pixels is above said pre-selected threshold.

16. The system of claim 13 wherein said comparator is further configured to
(a) determine a maximum first dimension for each said pre-selected section;
(b) determine a maximum second dimension for each said pre-selected section;
(c) assign said maximum first dimension for the selected scan line if no pixel of the plurality of pixels is above said pre-selected threshold; and
(d) assign said maximum second dimension for the selected scan line if no pixel of the plurality of pixels is above said pre-selected threshold.

17. The system of claim 13 wherein said comparator is further configured to
(a) determine a minimum first dimension for each said pre-selected section;
(b) determine a minimum second dimension for each said pre-selected section;
(c) assign said minimum first dimension for the selected scan line if no pixel of the plurality of pixels is above said pre-selected threshold; and
(d) assign said minimum second dimension for the selected scan line if no pixel of the plurality of pixels is above said pre-selected threshold.

18. The system of claim 13 wherein said comparator is further configured to
(a) determine a maximum first dimension and a minimum first dimension for each of said pre-selected sections;
(b) determine a maximum second dimension and a minimum second dimension for each of said pre-selected sections; and
(c) discard said maximum first dimension, said minimum first dimension, said maximum second dimension, and said minimum second dimension.

19. The system of claim 13 wherein said pre-selected section includes about 256 of said scan lines.

20. The system of claim 13 wherein said pre-selected section includes about 64 of said scan lines.

21. The system of claim 13 wherein said status processor is further configured to
(a) calculate a first skew angle of said first edge;
(b) calculate a second skew angle of said second edge; and
(c) identify said scanned image as a double feed if said first skew angle and said second skew angle are not substantially equal.

22. The system of claim 13 wherein said status processor is further configured to identify said scanned image as a double feed if there is at least one step in said first edge or if there is at least one step in said second edge.

23. A communications network comprising at least one node for carrying out the method according to claim 1.

24. A computer data signal embodied in electromagnetic signals traveling over a communications network carrying information capable of causing a computer system in the communications network to practice the method of claim 1.

25. A computer readable medium having instructions embodied therein for the practice of the method of claim 1.
